(19) United States
(12) Patent Application Publication
(10) Pub. No.: US 2024/0375274 A1
(43) Pub. Date: Nov. 14, 2024

(54) COORDINATED MOTION OF A MANIPULATOR AND MOBILE BASE

(71) Applicant: Southwest Research Institute, San Antonio, TX (US)

(72) Inventors: David M. MERZ, JR., Castroville, TX (US); Tiffany E. CAPPELLARI, San Antonio, TX (US); Matthew M. ROBINSON, San Antonio, TX (US); Tyler Stephen MARR, San Antonio, TX (US)

(21) Appl. No.: 18/661,192

(22) Filed: May 10, 2024

Related U.S. Application Data
(60) Provisional application No. 63/501,180, filed on May 10, 2023.

(51) Int. Cl. B25J 9/16

(52) U.S. Cl. CPC B25J 9/1607; B25J 9/162; B25J 9/163; B25J 9/1653; B25J 9/1666

(57) ABSTRACT

A single kinematic chain robotic control system, comprising global planning control circuitry configured to receive initial position data of a robotic manipulator having n_{J} joints and initial position data of a mobile base having n_{M} joints, where a joint has at least one degree of freedom. The global planning circuitry is further configured to receive a motion plan request that includes at least one waypoint for at least one articulating component coupled to one of the n_{J} joints of the robotic manipulator. A waypoint is a destination of the articulating component of the robotic manipulator in an external environment. The global planning circuitry comprises discretized determination circuitry to generate a first combined matrix of joint values for each of the n_{J} mobile base joints and the n_{M} robotic manipulator joints, based on the motion plan request and the initial position data and optimization circuitry configured to generate a second combined matrix of joint values for each of the n_{J} mobile base joints and the n_{M} robotic manipulator joints, based on the first combined matrix and one or more optimization parameters associated with the mobile base or the robotic manipulator. The single kinematic chain robotic control system further comprises matrix parsing circuitry configured to receive the second combined matrix and parse the second combined matrix to generate a third matrix of joint values for the robotic manipulator and a fourth matrix of joint values for the mobile robotic base.

### CROSS-REFERENCE TO RELATED APPLICATIONS

The present application claims the benefit of US Provisional Application Ser. No. 63/501,180, filed May 10, 2023, which is hereby incorporated by reference in its entirety.

### FIELD

The present disclosure is directed to a single kinematic chain robotic control system.

### BACKGROUND

A variety of automation tasks (e.g., painting, welding, or sealing) can stretch over relatively large work volumes while requiring continuous processing along an active edge. Relatively smooth motion is required over this large work volume, but the use of a sufficiently large single robotic manipulator is infeasible due to one of any number of constraints. Ideally, the installation should remain as resilient as possible to future task changes and require little in the way of installed infrastructure. In these situations, various methods have been tried for expanding the work volume of a relatively smaller robotic manipulator: collections of smaller manipulators, coordinated motion between manipulators and external axes, and coordinated motion between manipulators and mobile bases.

Relatively large manipulators may be infeasible for any number of reasons. A given work volume, while large, may have little headroom, causing a manipulator with relatively long reach to bump the ceiling or floor when moving through the middle of its work volume. Physical constraints mean relatively large manipulators are often less precise than relatively small manipulators and must move more slowly. Relatively larger manipulators are typically more expensive, and in some cases a sufficiently large robot may simply not be commercially available.

One solution is to use a plurality of manipulators. This can reduce cost and increase the precision over the work volume but binds the automated solution to a particular location. The manipulators must be coordinated to avoid colliding and to keep active processing edges. In applications with any variation in tasking, close coordination among standard 6-degree-of-freedom (6-DOF) manipulators can be relatively complex. Nevertheless, this solution can work in extremely low-mix contexts.

A more common solution is to coordinate motion between a manipulator and external axes (a rail or a gantry) on which it has been installed. This allows a manipulator's reach to be expanded in one or more well-defined dimensions with good precision. External axes are well-developed, and manipulators from many manufacturers can integrate smoothly with rails and gantries. However, relatively large rails or gantries can become expensive. This solution also requires a substantial infrastructure investment binding an automated system to a particular location. Furthermore, changes in tasking are likely to be incompatible with the external axes' defined work volumes.

Due to the expense and inflexibility of fixed external axes, various groups have attempted to expand the reach of a robotic system by mounting relatively small manipulators on mobile platforms. Mobile platforms, while able to move freely without fixed infrastructure, are not as precise as traditional external axes. The manipulator, which generally has greater precision, is used to accommodate for errors in the platform's motion. However, there are limits to the manipulator's effective reach, and therefore the limits to the maximum error correction.

Coordinated motion of a mobile platform and robotic manipulator is the current peak of price and adaptability for relatively large workspaces. However, currently available coordinated motion solutions rely on external tracking infrastructure. Tracking systems have become more affordable over time, but the price still expands as the desired work area expands. Furthermore, the installation of the tracking system places limits on available workspaces and once again limits the system to a particular area, making expansion or movement to a new area very expensive.

### BRIEF DESCRIPTION OF THE DRAWINGS

The various aspects and advantages of the present disclosure may be better understood by reference to the following detailed description, in conjunction with the accompanying drawings, wherein:

FIG. 1A illustrates a robotic system performing a function along a wall, wherein the robotic system is not configured to generate a modified motion plan based at least in part of an initial motion plan and feedback from one or more sensors.

FIG. 1B illustrates a robotic system as it performs a task along a wall, wherein the robotic system is configured to generate a modified motion plan based at least in part of an initial motion plan and feedback from one or more sensors.

FIG. 1C illustrates a robotic manipulator and a mobile base.

FIG. 2 depicts a schematic a preferred embodiment of the unified control circuit of the robotic system.

FIG. 3 depicts a flow chart of a preferred embodiment of the method of generating an initial and modified motion plan.

FIG. 4 depicts a flow chart of a preferred embodiment of the method of discrete step determination.

FIG. 5 depicts a flow chart of a preferred embodiment of the method of continuous optimization.

FIG. 6 depicts a flow chart of a preferred embodiment of the method of generating a modified motion plan.

### SUMMARY

The present disclosure relates to a single kinematic chain robotic control system, comprising global planning control circuitry configured to receive initial position data of a robotic manipulator having n_{J} joints and initial position data of a mobile base having n_{M} joints, where a joint has at least one degree of freedom. The global planning circuitry is further configured to receive a motion plan request that includes at least one waypoint for at least one articulating component coupled to one of the n_{J} joints of the robotic manipulator. A waypoint is a destination of the articulating component of the robotic manipulator in an external environment. The global planning circuitry comprises discretized determination circuitry to generate a first combined matrix of joint values for each of the n_{J} mobile base joints and the n_{J} robotic manipulator joints, based on the motion plan request and the initial position data and optimization circuitry configured to generate a second combined matrix of joint values for each of the n_{J} mobile base joints and the n_{J} robotic manipulator joints, based on the first combined matrix and one or more optimization parameters associated with the mobile base or the robotic manipulator. The single kinematic chain robotic control system further comprises matrix parsing circuitry configured to receive the second combined matrix and parse the second combined matrix to generate a third matrix of joint values for the robotic manipulator and a fourth matrix of joint values for the mobile robotic base.

The present disclosure also relates to a non-transitory storage device that includes machine-readable instructions that, when executed by one or more processors, cause the one or more processors to perform operations, comprising generating a first combined matrix of joint values each of joint of a robotic manipulator having n_{J} joints and each joint of a mobile base having n_{M} joints, based on a motion plan request, initial position data of the robotic manipulator and initial position data of the mobile robotic base. The motion plan request includes at least one waypoint for at least one articulating component of the robotic manipulator. A waypoint is a destination of the articulating component of the robotic manipulator in an external environment. The present disclosure additionally relates to a non-transitory storage device that includes machine-readable instructions that, when executed by one or more processors, cause the one or more processors to perform operations, further comprises generating a second combined matrix of joint values for each of the n_{J} mobile base joints and the n_{M} robotic manipulator joints, based on the first combined matrix and one or more optimization parameters associated with the mobile base or the robotic manipulator and parsing the second combined matrix to generate a third matrix of joint values for the robotic manipulator and a fourth matrix of joint values for the mobile robotic base.

### DETAILED DESCRIPTION

The present disclosure is generally related to a controller for a robotic system. More specifically, the present disclosure relates to a controller for a robotic system having a robotic manipulator mounted to a mobile base, wherein the controller is configured to treat the robotic manipulator and mobile base as a single kinematic chain.

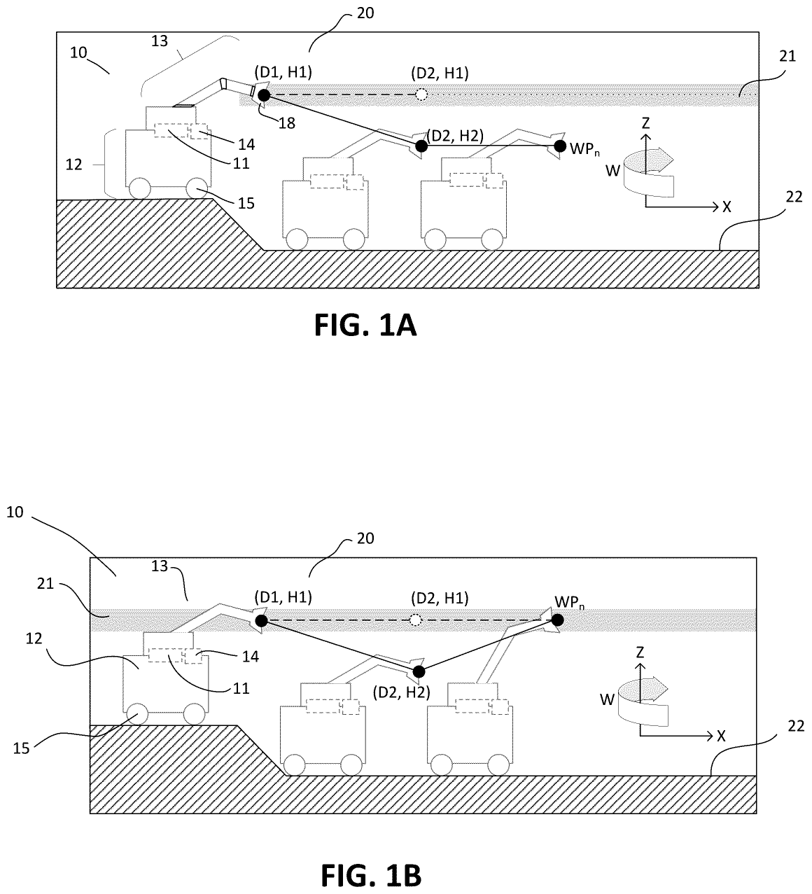

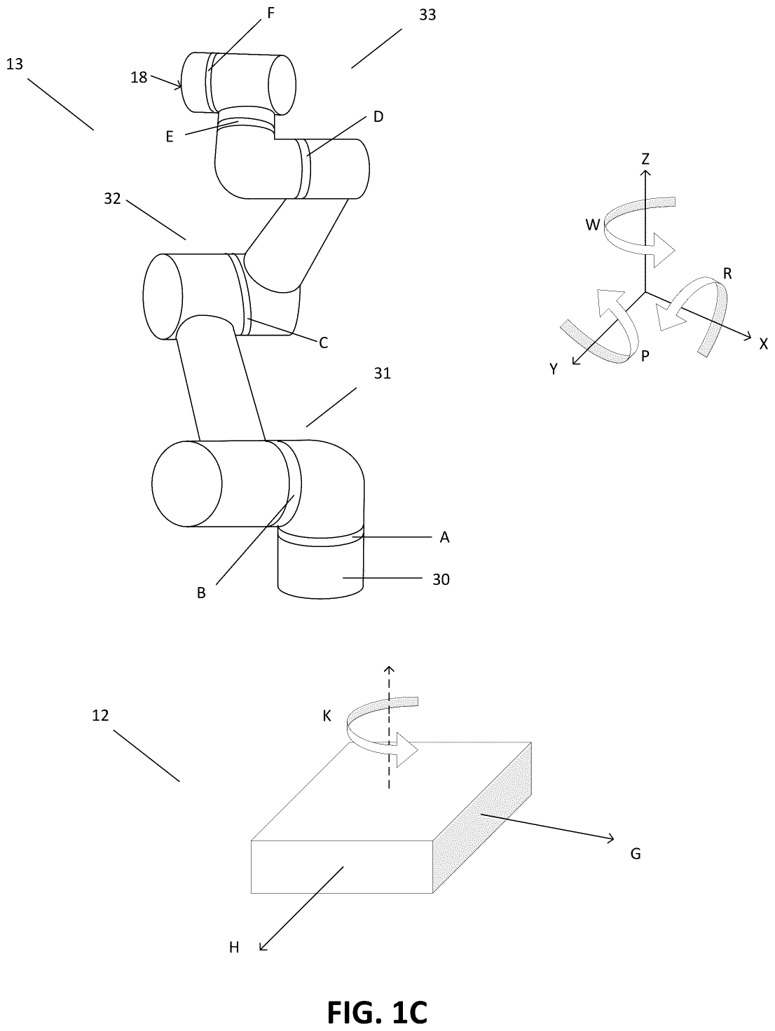

As shown in FIGS. 1A & 1B, a preferred embodiment of the robotic system 10 may preferably comprise a mobile base 12, a robotic manipulator 13, one or more sensors 14, and a controller 11 (e.g., control system) communicatively coupled to the one or more sensors. The mobile base 12 may preferably have a vehicle propulsion system configured to move said robotic system 10 along the x-axis, shown in FIGS. 1A & 1B, and the y-axis, where the y-axis is perpendicular to the surface on which the figure rests, and to rotate the robotic system about the z-axis (i.e., “yaw”; represented by the variable W). Preferably, as shown in FIGS. 1A & 1B, the robotic system 10 may include one or more wheels 16.

Furthermore, the mobile base 12 is preferably configured to support robotic manipulator 13. Preferably, robotic manipulator 13 is mounted onto mobile base 12. The robotic manipulator 13 preferably includes one or more joints. The robotic manipulator 13 further preferably includes at least one articulating component coupled to one of the joints. An articulating component may be an attachment end 18 configured to cooperate with a tool configured to perform one or more operation on an environment. For example, the attachment end 18 may include an adjustable connector configured to accommodate different size tools. In this example, the adjustable connector includes a gripping mechanism configured to grasp tool. By way of a further example, the attachment end 18 may include a fixed connector. In this example, the fixed connector includes a threaded connector, a bayonet fitting, a press-fit, a snap-fit, and/or any other fixed connector.

As shown in FIG. 1C, the positions and orientations of the robotic system 10 are defined with respect to a coordinate system having three translational axis, X, Y, and Z, and three rotational axis, R (“roll”), P (“pitch”), and W (“yaw). FIG. 1C depicts a preferred embodiment of the robotic manipulator 13 and the mobile base 12. The robotic manipulator 13 may have six joints (A, B, C, D, E, and F) each capable of rotating about a single axis which causes translation of the attachment end 18. The attachment end 18 is positioned after the last joint F of the robotic manipulator 13 and a mounted end 30 configured to be mounted onto the mobile base 12 is position before the first joint A. For purposes of defining configurations of possible joint state solutions using known inverse kinematics as discussed below, FIG. 1C depicts the portions of the robotic manipulator deemed the shoulder 31, the elbow 32, and the wrist 33. The shoulder 31 comprises the portions of the robotic manipulator 13 adjacent to joint B on both sides of the joint. The shoulder 31 has two configurations-left and right. The left configuration of the shoulder 31 refers to the orientation of the elbow 31 within the external environment when joint A is at an orientation about its rotational axis between 0 degrees and 180 degrees while the right configuration of the shoulder 31 refers to the orientation of the shoulder within the external environment when joint A is at an orientation about its rotational axis between 180 degrees and 360 degrees. The elbow 32 comprises the portions of the robotic manipulator 13 adjacent to joint C on both sides of the joint. The elbow 32 has two configurations-up and down. The up configuration of the elbow 32 refers to the orientation of the elbow 32 within the external environment when joint Cis at an orientation about its rotational axis between 0 and 180 degrees while the down configuration of the elbow 32 refers to the orientation of the elbow 32 within the external environment when joint Cis at an orientation about its rotational axis between 180 and 360 degrees. The wrist 33 comprises the portions of the robotic manipulator 13 adjacent to joint E and D on both sides of the joints. The wrist 33 has two configurations-up and down. The up configuration of the wrist 33 refers to the orientation of the wrist 33 within the external environment when joint D is at an orientation about its rotational axis between 0 and 180 degrees while the down configuration of the wrist 33 refers to the orientation of the wrist 33 within the external environment when joint D is at an orientation about its rotational axis between 180 and 360 degrees. Thus, as is well known, with respect to the robotic manipulator 13, there are 8 inverse kinematics solutions where there are 8 possible combinations of shoulder 31, elbow 32, and wrist 33 configurations.

Also depicted in FIG. 1C is a preferred embodiment of the mobile base 12. The mobile base 12 may have three joints (G, H, and K) where joint G represents the mobile base's 12 motion along the x-axis, joint H represents the mobile base's motion along the y-axis, and joint K represents the mobile base's rotation along the P axis. The rotation of one or more of the six joints (A, B, C, D, E, and F) cause the attachment end 18 to translate in the X, Y, Z axes.

Using the six joints of the robotic manipulator (A, B, C, D, E, and F) and the three joints of the mobile base (G, H, and K), robotic manipulator 13 and mobile base 12 can translate and rotate the attachment end 18 with six degree of freedom (“6-DOF”). Herein, 6-DOF refers to the attachment end 18 moving laterally along each of the X, Y, Z axes and rotating along the R, P, W axes.

The position/orientation of each joint of the robotic manipulator 13 and the mobile base 12 about or along their respective axis is referred to as a joint state. Further, the joint state values of the six joints of the robotic manipulator 13 are represented as follows: J1, J2, J3, J4, J5, and J6. The joint state values of the three joints of the mobile base 12 are represented as follows: M_{X}, M_{Y}, M_{W}. A joint state is preferably produced by a motor, more preferably a servo motor.

The controller 11 is configured to generate one or more motion plans (e.g., initial motion plan, modified motion plan, etc.) and cause the robotic system 10 to move according to the one or more motion plans. A motion plan may be understood to be a set of joint values for each joint of the robotic manipulator 13 and mobile base 12 in order to produce a desired a movement path of the attachment end 18. The movement path is defined by one or more waypoints. Herein, waypoint is a destination (X, Y, Z, R, P, W) of the attachment end 18 within an external environment.

The mobile base 12 and the robotic manipulator 13 are individually moved, where the motions are synchronized with one another, by the controller 11 according to the motion plan. Synchronization of the individual movements of the mobile base 12 and robotic manipulator 13 according to a motion plan may include coordinating the movement of the mobile base 12 with the robotic manipulator 13 such that the mobile base 12 and the robotic manipulator 13 may engage in coordinated motion to complete a task. For example, where the task is painting a wall 20 along a length of the wall, the controller 11 may cause the mobile base 12 to move laterally along the length of the wall while causing the robotic manipulator 13 to perform brushstrokes on the wall. By synchronizing the lateral movement of the mobile base 12 and the brushstrokes of the robotic manipulator 13, the robotic system 10 is able to complete the painting task along the entire length of the wall 20. In this way, the mobile base 12 and robotic manipulator 13 may perform a task under a single, unified control scheme, allowing the robotic system 10 to perform gantry-like motion without using a gantry or a rail.

Synchronization may further involve using one or more interfaces between the controller 11 and the mobile base 12 and robotic manipulator 13 to maintain coordination. The interface(s) may employ messaging techniques to communicate motion plans between the controller 11 and the mobile base 12 and robotic controller 13.

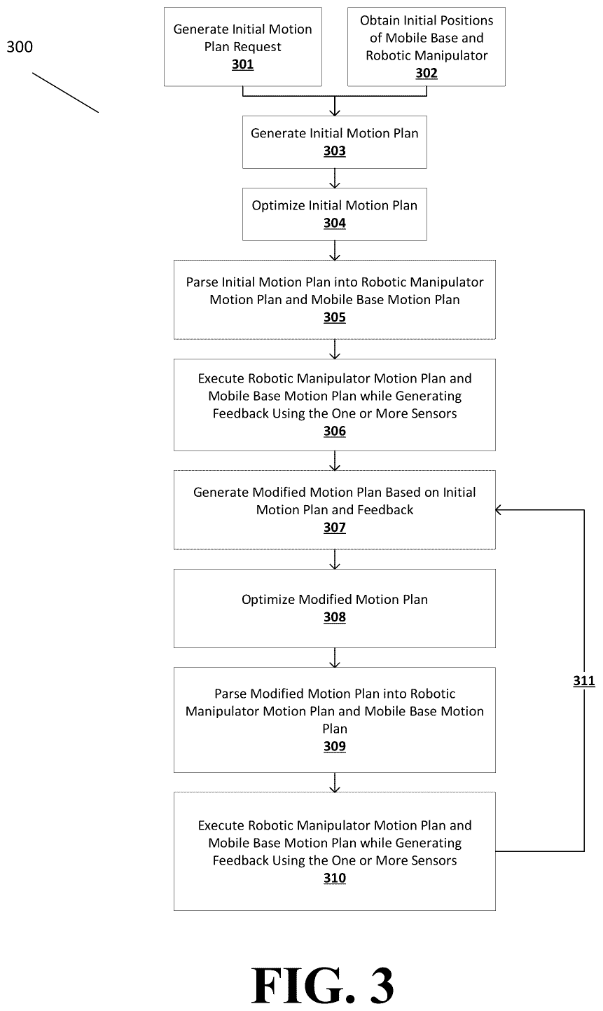

An embodiment of the method of generating and modifying motion plans for a robotic system 300 is depicted in FIG. 3. Step 301 comprises generating an initial motion plan request which includes an intended movement path of the attachment end 18, supplied for example by the user, external markers, and/or prior operations. Step 302 comprises obtaining the initial positions of the robotic manipulator 13 and mobile base 12, supplied for example by the user, external markers, and/or prior operations. Step 303 comprises the controller 11 generating an initial motion plan configured to cause the attachment end 18 of the robotic system 10 to move along an intended trajectory 21 using the initial motion plan request generated in step 301 and the initial positions of the mobile base 12 and robotic manipulator 13 obtained in step 302. An initial plan herein, is a reference to the initial movement of the mobile base 12 and/or manipulator 13. The initial motion plan may preferably optimized in step 304 and parsed by the controller 11 to generate an initial mobile base motion plan and an initial robotic manipulator motion plan in step 305. The initial mobile base motion plan and the initial robotic manipulator motion plan may preferably be time-synchronized. Step 306 comprises the controller 11 causing the mobile base 12 to move according to the initial mobile base motion plan and the robotic manipulator 13 to move according to the initial robotic manipulator motion plan such that the attachment end 18 of the robotic system 10 moves along the intended trajectory 21.

The controller 11 may be configured to cause the mobile base 12 and the robotic manipulator 13 to move according to their respective initial motion plans for a predetermined period while the one or more sensors 14 generate the feedback. As the mobile base 12 and robotic manipulator 13 move according to their respective initial motion plans, the actual movements carried out by the mobile base 12 and/or robotic manipulator 13 may not conform to the intended movements dictated by their respective motion plans due to internal conditions (e.g., delays in signal transmission, low precision motors etc.) or external surface conditions (e.g., low friction surfaces, undulating surfaces, obstruction, etc.). To account for these errors, the controller 11 may preferably use the one or more sensors 14 to capture feedback data on the location of the mobile base 12 and/or position of the robotic manipulator 13 (e.g., localization points). As such, in step 307, the controller 11 may be configured to, after the expiration of the predetermined period, generate a modified motion plan based, at least in part, on the initial motion plan and the feedback from the one or more sensors 14.

The predetermined period may preferably be in the range of 1 millisecond to 3000 milliseconds. More preferably, the predetermined period may be in the range of 2 milliseconds to 20 milliseconds.

The one or more sensors 14 may preferably be a joint encoder, an optical sensor (e.g., a camera, a Light Detection and Ranging (LIDAR) sensor, an infra-red sensor, and/or any other optical sensor), an ultrasonic sensor, accelerometer, an inertial measurement unit (IMU), and/or any other sensor. The one or more sensors 14 may be located on the mobile base 12 and/or the robotic manipulator 13. For example, the mobile base 12 may include one or more sensors 14 to detect the location of the mobile base 12 and/or the robotic manipulator 13 may have one or more sensors 14 to detect the position of the robotic manipulator 13.

The controller 11 may preferably be capable of high frequency joint feedback. High frequency joint feedback refers to the controller 11 communicating with the one or more sensors 14 to receive feedback on the location of the mobile base 12 and/or the position of the robotic manipulator 13. High frequency refers to the frequency at which the controller 11 receives feedback from the one or more sensors 14 at the controller's 11 peak processing capacity. For example, the controller 11 may receive feedback from the sensors 14 at a rate of at least 10 Hz, more preferably in the range of 30 to 100 Hz.

Using the sensor feedback, the controller 11 may generate the modified motion plan to account for deviations from the intended trajectory 21 of the robotic system 10. The modified motion plan may be optimized in step 308 and parsed by the controller 11 to generate a modified mobile base motion plan and a modified robotic manipulator motion plan in step 309. The modified mobile base motion plan and the modified robotic manipulator motion plan may preferably be time synchronized. The controller 11 may also be configured to, in step 310, after the modified motion plan is generated, cause the mobile base 12 to move according to the modified mobile base motion plan and the robotic manipulator 13 to move according to the modified robotic manipulator motion plan. Steps 307, 308, 309, and 310 may be repeated as shown by arrow 311 in FIG. 3, on a periodic basis as the robotic system executes waypoints along the motion plan and collects feedback from the one or more sensors.

The feedback containing the actual location of the mobile base 12 and/or position of the robotic manipulator 13 may be used to generate the modified motion plan by adopting the waypoints of the initial motion plan yet to be executed and modifying those waypoints to account for the difference between the actual location of the mobile base 12 and/or position of the robotic manipulator 13 and the intended location of the mobile base 12 and/or position of the robotic manipulator 13 according to the initial motion plan.

For example, FIGS. 1A & 1B depict a robotic manipulator 13 performing the task of painting a wall 20 along a path without the ability to detect actual motion and modify the motion plan (FIG. 1A) and with the ability to detect actual motion and modify the motion plan (FIG. 1B). More specifically, the task to be performed by the robotic system 10 in FIGS. 1A & 1B is painting a wall 20 along a length of the wall, the controller 11 may cause the mobile base 12 to move the robotic system 10 laterally along the length of the wall while causing the robotic manipulator 13 to perform brushstrokes on the wall 20. The controller 11 may generate an initial motion plan configured to move the robotic system 10 so as to cause the attachment end 18 to move along an intended trajectory 21 required to perform the task. However, the surface 22 on which the mobile base 12 laterally moves may undulate, causing the entire robotic system 10 to rise and fall with the rise and fall of the undulating surface 22. Thus, as shown in FIG. 1A, the initial motion plan may intend for the robotic system 10 to move such that the attachment end 18 may move laterally from D1 to D2 while maintaining an initial vertical position H1; however, because of the undulating surface 22, the attachment end 18 may move laterally to D2 and vertically to H2. After the move, the controller 11 expects attachment end 18 to be at waypoint (D2, H1) but the attachment end 18 is actually at location (D2, H2). If the mobile base 12 were to continue to move based on the initial motion plan, the vertical error in the position of the attachment end 18 would be introduced to all subsequent waypoints WPₙ and the initial motion plan will no longer cause the robotic system to move such that the attachment end 18 moves along the intended trajectory 21. Thus, as shown in FIG. 1B, according to the present disclosure, the one or more sensors 14 may send feedback to the controller 11 including the actual position of the attachment end-(D2, H2)—and account for the difference between the intended waypoint (D2, H1) and the actual location (D2, H2), thereby ensuring the modified motion plan is configured to return the attachment end 18 to the intended trajectory 21.

In this way, the mobile base 12 and robotic manipulator 13 may perform a function under a single, unified control scheme, allowing the robotic system 10 to perform gantry-like motion in spite of precision limitations of the mobile base 12 without using a gantry, rail, or external tracking/localization equipment. The system avoids the need for external measurement devices (e.g., external cameras) or infrastructure (e.g., boundary wires or painted markings on the floor or ceiling). Thus, the robotic system 10 may perform a function over a large area, wherein the mobile base 12 moves along an undulating and/or low friction surface while the robotic manipulator 13 moves to maintain a spatial position within the environment.

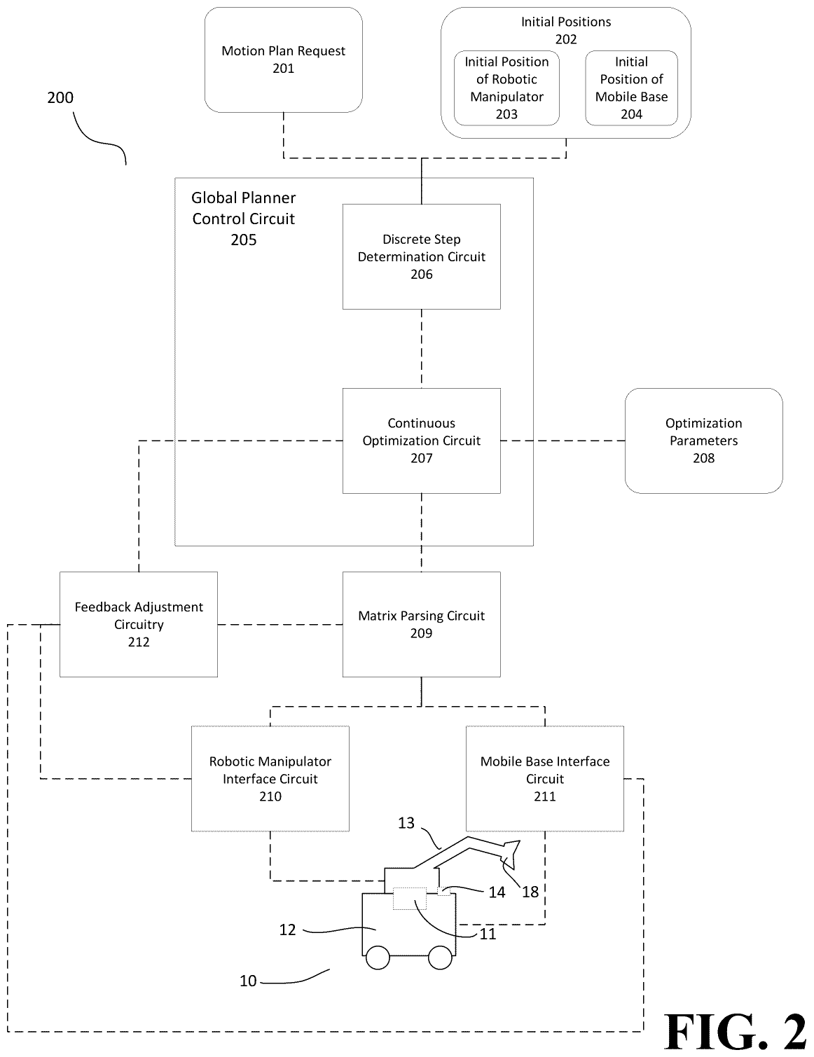

More specifically, as shown in FIG. 2, the robotic system 10 may preferably generate and execute the initial and modified motion plans using a unified control circuit 200. The unified control circuit 200 may preferably comprise a global planner control circuit 205, a matrix parsing circuit 209, a feedback adjustment circuit 212, an interface circuit in communication with the robotic manipulator 210, and an interface circuit in communication with the mobile base 211. The global planner control circuit 205 may preferably have subcircuits including a discrete step determination circuit 206 and a continuous optimization circuit 207. The discrete step determination circuit 206 may preferably be configured to receive a motion plan request 201 and the initial positions of the robotic manipulator 203 and the mobile base 204.

The discrete step determination circuit 206 is configured to receive the motion plan request 201, for example, through user input, by sensing external markers, and/or using motion plans from prior operations of the robotic system, and to receive the initial joint states of the robotic manipulator 203 and the mobile base 204 for example, from user input, location data gathered using one or more sensors in the external environment and/or on the mobile base and/or robotic manipulator, and/or from prior operations of the robotic system.

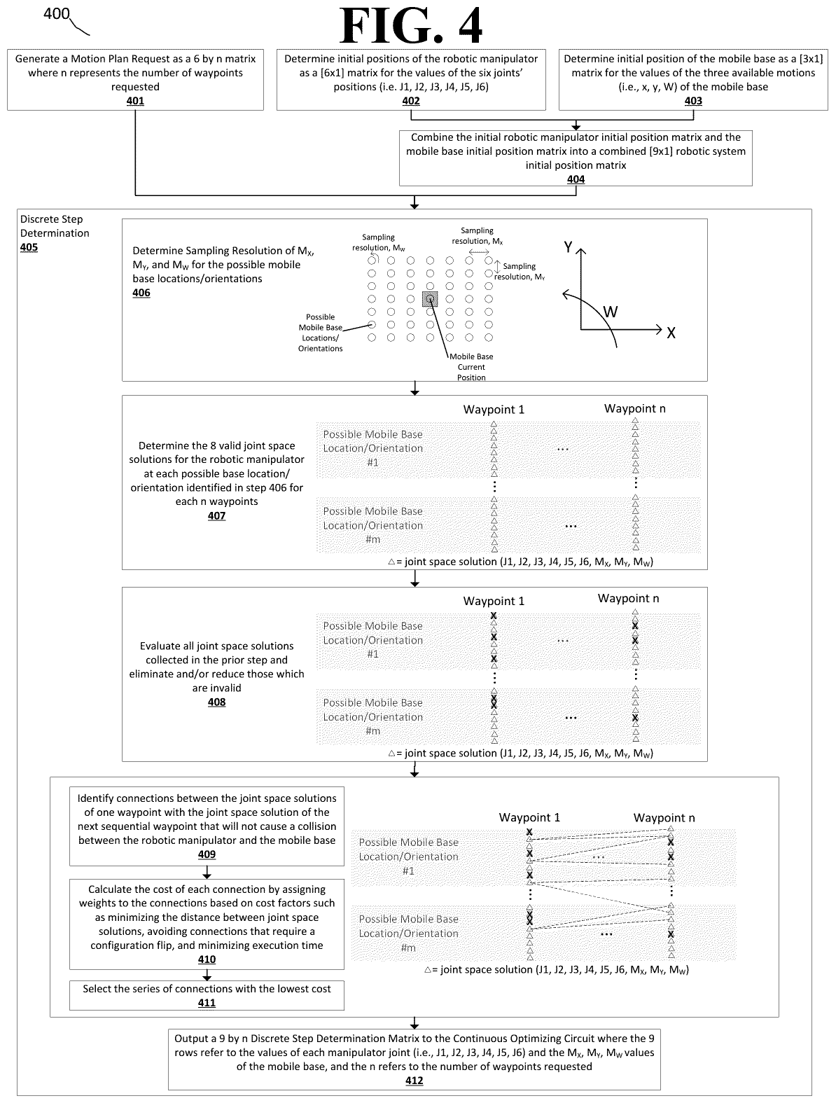

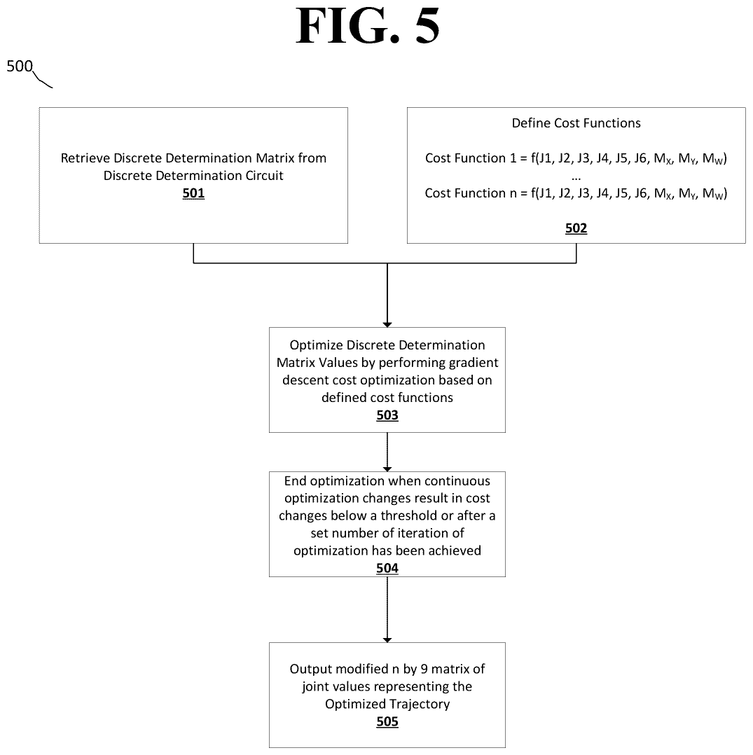

More specifically, as depicted in FIG. 4, the motion plan request 201 is generated in step 401 as 6 by n matrix where each column in the matrix represents a desired waypoint and n represents the number of waypoints specified. Each row of the motion plan request matrix represents the X, Y, Z, R, P, and W value of the waypoint. The following represents the motion plan request matrix:

$$[ \begin{matrix}{X}_{WP 1} & … & {X}_{WPn} \\ {Y}_{WP 1} & … & {Y}_{WPn} \\ {Z}_{WP 1} & … & {Z}_{WPn} \\ {R}_{WP 1} & … & {R}_{WPn} \\ {P}_{WP 1} & … & {P}_{WPn} \\ {W}_{WP 1} & … & {W}_{WPn}\end{matrix} ]$$

The initial position of the robotic manipulator 203 may be generated in step 402 as a n_{J}×1 matrix where each row represents a joint of the robotic manipulator and n_{J} represents the number of joints in the robotic manipulator. Thus, for the embodiment discussed above wherein the robotic manipulator has six joints A, B, C, D, E, F configured respectively to move according to joint states J1, J2, J3, J4, J5, and J6, the robotic manipulator initial position matrix may be defined as follows,

$$[ \begin{matrix}{J}_{1} \\ {J}_{2} \\ {J}_{3} \\ {J}_{4} \\ {J}_{5} \\ {J}_{6}\end{matrix} ]$$

The initial position of the mobile base 204 may be generated in step 403 as a n_{M} by 1 matrix where each row represents an available joint of the mobile base and n_{M} represents the quantity of joints the mobile base. Thus, for the embodiment discussed above wherein the mobile base has three joints G, H, and K which respectively allow the mobile base to move in the X, Y, and W axes using joint states M_{X}, M_{Y}, M_{W}, the mobile base initial position matrix may be defined as follows,

$$[ \begin{matrix}{M}_{X} \\ {M}_{Y} \\ {M}_{W}\end{matrix} ]$$

The discrete step determination control circuit 206 may preferably be configured to amend the mobile base initial position matrix to the end of the robotic manipulator initial position matrix to generate the following 9 by 1 robotic system initial position 202 matrix, as depicted in step 404:

$$[ \begin{matrix}{J}_{1} \\ {J}_{2} \\ {J}_{3} \\ {J}_{4} \\ {J}_{5} \\ {J}_{6} \\ {M}_{X} \\ {M}_{Y} \\ {M}_{W}\end{matrix} ]$$

The discrete step determination control circuit 206 may preferably be configured to generate a 9 by n matrix where each row represents a joint state of the robotic manipulator and mobile base and each column represents the values of the joint states that will cause the attachment end to reach a waypoint along the intended trajectory. For example, the value in the matrix at location [0,0] may represent the joint state J1 required to cause the attachment end to reach the first waypoint. The discrete step determination control circuit 206 may generate these values by performing steps 406, 407, 408, 409, 410, and 411. The discrete step determination matrix may be defined as follows,

$$[ \begin{matrix}{J}_{1 @ {WP}_{1}} & … & {J}_{1 @ {WP}_{n}} \\ {J}_{2 @ {WP}_{1}} & … & {J}_{2 @ {WP}_{n}} \\ {J}_{3 @ {WP}_{1}} & … & {J}_{3 @ {WP}_{n}} \\ {J}_{4 @ {WP}_{1}} & … & {J}_{4 @ {WP}_{n}} \\ {J}_{5 @ {WP}_{1}} & … & {J}_{5 @ {WP}_{n}} \\ {J}_{6 @ {WP}_{1}} & … & {J}_{6 @ {WP}_{n}} \\ {M}_{X @ {WP}_{1}} & … & {M}_{X @ {P}_{n}} \\ {M}_{Y @ {WP}_{1}} & … & {M}_{Y @ {P}_{n}} \\ {M}_{W @ {WP}_{1}} & … & {M}_{W @ {P}_{n}}\end{matrix} ]$$

Step 406 comprises determining the sampling resolution of M_{X}, M_{Y}, M_{W} for the possible locations/orientations of the mobile base. This will generate a plurality of M_{X}, M_{Y}, M_{W} positions/orientation of the mobile base representing the possible locations/orientations the mobile base may move to during the execution of a waypoint. Step 407 comprises using known inverse kinematics methods to determine the 8 valid joint space solutions for the robotic manipulator, as discussed above, at each possible location/orientation of the mobile base generated in step 406 for each n waypoint. Each valid joint space solution contains values for J1, J2, J3, J4, J5, J6, M_{X}, M_{Y}, and M_{W}. Thus, step 407 generates 8 valid joint space solutions for each possible mobile base location/orientation (#m) for each waypoint in the motion plan request.

Step 407 comprises evaluating the joint space solutions collected in step 406 and reducing and/or eliminating invalid joint space solutions such as those which would cause the robotic manipulator 13 to collide with the mobile base 12, itself, and/or something in the external environment, cause a singularity, and/or cause a weight distribution instability in the robotic system 10. Herein a singularity refers to a waypoint where inverse kinematics is mathematically unstable, such as where the shoulder 31 is within a specific margin of the point where the shoulder 31 shifts between the left and right configurations, where the elbow 32 is within the specific margin of the point where the elbow 32 shifts between the up and down configuration, and/or where the wrist 33 is within the specific margin of the point where the wrist 33 shifts between the up and down configurations. The specific margin refers to a configuration of the shoulder 31, elbow 32, and/or wrist 33 where the shoulder 31, elbow 32 and/or wrist 33, respectively, are positioned at a distance from the transition between configurations less than or equal to 2% of the robotic manipulator's 13 maximum extension distance.

Steps 409, 410, and 411 deal with identifying possible paths between successive waypoints, assigning weights to each path based on one or more cost functions, and selecting a path with the lowest cost. More specifically, step 409 comprises identifying the connections between the joint space solutions of one waypoint with the joint space solutions of the next sequential waypoint and reducing and/or eliminating the connections that would result in a collision between the robotic manipulator and the mobile base, itself, or the external environment, cause a singularity, cause a joint of the robotic manipulator and/or mobile base to reach the maxima or minima of its range of motion, and/or cause a weight distribution instability. Further, step 410 comprises calculating the cost of each connection identified in step 409 by assigning weights to each connection based on cost factors. The cost factors are functions of nine values, each representing the path between successive joint state solutions for each of the nine joints A, B, C, D, E, F, G, H, and K. The output of the cost functions is a scalar value representing the favorability of the path based on minimizing the required travel distance along the path between successive waypoints, reducing the instances where the shoulder, wrist, or elbow configurations change between successive waypoints, and/or reducing the velocity and/or acceleration at the joints. Step 411 comprises evaluating all possible routes between waypoints and their respective cost factor weights to select the path that connects a joint state from each waypoint with the lowest cost. Step 412 comprises converting the path selected in step 411 into the discrete step determination matrix, shown above.

The continuous optimization circuit 207 may preferably be configured to optimize the values within the discrete step determination matrix based on optimization parameters 208. The optimization parameters 208 may, for example, instruct the continuous optimization circuit 207 to optimize the values within the discrete step determination matrix so the robotic manipulator and mobile base stay within the acceleration limits of the robotic manipulator and/or mobile base and avoid singularities and unstable positions. The discrete step determination matrix is then transmitted to the continuous optimization circuit 207 in step 501 as depicted in FIG. 5. Step 502 comprises defining cost functions, where a cost function is a function of J1, J2, J3, J4, J5, J6, M_{X}, M_{Y}, and M_{W}. Step 503 comprises optimizing the values in the discrete step determination matrix by performing gradient descent cost optimization based on the defined cost functions generated in step 502. Step 504 comprises terminating the optimization when the continuous optimization changes result in cost changes below a specific threshold or after a set number of optimizations have been achieved. Step 505 comprises outputting a 9 by n optimized trajectory matrix, as follows,

$$[ \begin{matrix}{J}_{1 @ {WP}_{1}}^{′} & … & {J}_{1 @ {WP}_{n}}^{′} \\ {J}_{2 @ {WP}_{1}}^{′} & … & {J}_{2 @ {WP}_{n}}^{′} \\ {J}_{3 @ {WP}_{1}}^{′} & … & {J}_{3 @ {WP}_{n}}^{′} \\ {J}_{4 @ {WP}_{1}}^{′} & … & {J}_{4 @ {WP}_{n}}^{′} \\ {J}_{5 @ {WP}_{1}}^{′} & … & {J}_{5 @ {WP}_{n}}^{′} \\ {J}_{6 @ {WP}_{1}}^{′} & … & {J}_{6 @ {WP}_{n}}^{′} \\ {M}_{X @ {WP}_{1}}^{′} & … & {M}_{X @ {P}_{n}}^{′} \\ {M}_{Y @ {WP}_{1}}^{′} & … & {M}_{Y @ {P}_{n}}^{′} \\ {M}_{W @ {WP}_{1}}^{′} & … & {M}_{W @ {P}_{n}}^{′}\end{matrix} ]$$

The continuous optimization circuit 207 may preferably be in communication with matrix parsing circuit 209, so that the continuous optimization circuit 207 may transmit the optimized trajectory matrix to the matrix parsing circuit 209. The matrix parsing circuit 209 may then process a single column of the optimized trajectory matrix (i.e., the joint states of the robotic manipulator and the mobile base at the first waypoint) by sending the first six rows (referring to the joint states of J1, J2, J3, J4, J5, and J6 at waypoint 1) to the robotic manipulator interface circuit 210 and sending the last three rows (referring to M_{X}, M_{Y}, and M_{W}) to the mobile base interface 211. By illustration, when executing the motion for the first waypoint, matrix parsing circuit 209 may preferably transmit the following matrix to the robotic manipulator interface circuit 210,

$$[ \begin{matrix}{J}_{1 @ {WP}_{1}}^{′} \\ {J}_{2 @ {WP}_{1}}^{′} \\ {J}_{3 @ {WP}_{1}}^{′} \\ {J}_{4 @ {WP}_{1}}^{′} \\ {J}_{5 @ {WP}_{1}}^{′} \\ {J}_{6 @ {WP}_{1}}^{′}\end{matrix} ]$$

and the following matrix to the mobile base interface circuit 211,

$$[ \begin{matrix}{M}_{X @ {WP}_{1}} \\ {M}_{Y @ {WP}_{1}} \\ {M}_{W @ {WP}_{1}}\end{matrix} ]$$

The robotic manipulator interface circuit 210 and the mobile base interface circuit 211 may preferably use the values in the transmitted matrices to transmit position commands to the robotic manipulator 13 and mobile base 12, respectively. The position commands may preferably cause the joints of robotic manipulator 13 and mobile base 12 to move to the specified joint state such that the attachment end 18 moves according to the intended trajectory.

The one or more sensors 14 of the robotic system 10 is/are configured to collect robotic manipulator and robotic base position feedback. The position feedback may include matrices containing the actual locations of the robotic manipulator 13 and mobile base 12 at each joint.

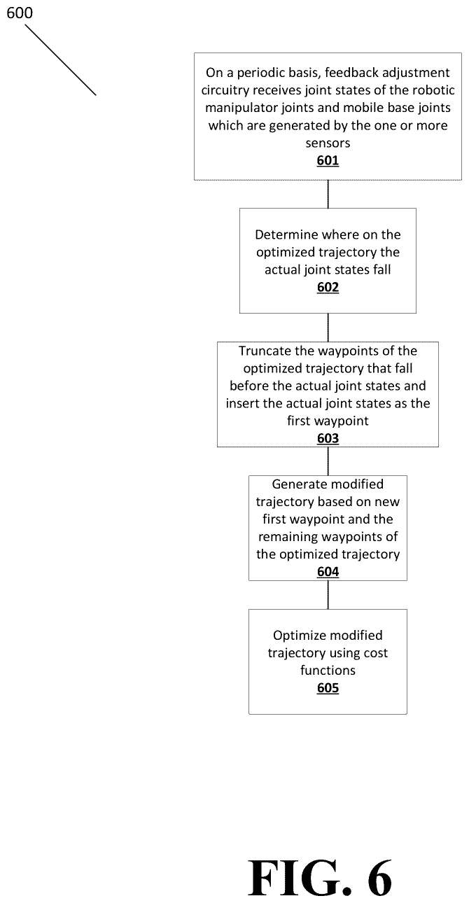

FIG. 6 depicts the method of gathering position feedback from the one or more sensors and generating a modified trajectory based, at least in part, on the feedback and the optimized trajectory matrix 600. Step 601 comprises the real-time planner receiving feedback containing the actual joint states of the robotic manipulator and the mobile base. The actual joint states of the robotic manipulator are transmitted to feedback adjustment circuit 212 from the robotic manipulator interface circuit 210 as a 6 by 1 actual joint state matrix containing the joint state values for the six joints J1, J2, J3, J4, J5, and J6 of the robotic manipulator 13. Likewise, the actual joint states of the mobile base are transmitted to the feedback adjustment circuit 212 from the mobile base interface circuit 211 as a 3 by 1 actual joint state matrix containing the joint state values for the three joints M_{X}, M_{Y}, and M_{W} of the mobile base 12. The feedback adjustment circuit 212 may be configured to combine the joint state matrices of the mobile base and robotic manipulator into a 9 by 1 combined robotic system actual joint matrix which produced the present X, Y, Z, R, P, W location of the attachment end 18.

Step 602 comprises determining the location where on the optimized trajectory the actual joint state matrix falls. For example, the optimized trajectory may have joint states for each of 4 planned waypoints. The actual joint states may fall between the set of joint states in the optimized trajectory for the second waypoint and the set of joint states in the optimized trajectory for the third waypoint.

Step 603 comprises generating a truncated optimized trajectory by inserting the actual joint state matrix into the optimized trajectory matrix at the location identified in step 602 and removing any columns in the optimized trajectory matrix that precede the newly inserted column of actual joint states. Thus, the truncated optimized trajectory matrix contains a first column representing the actual joint states and n columns representing the joint states of the waypoints of the original optimized trajectory matrix which have not yet been reached by the robotic system.

Step 604 comprises using the truncated optimized trajectory matrix to generate a modified trajectory matrix. The modified trajectory matrix is a 9 by n matrix where the nine rows refer to the joint states of the nine joints that cause the robotic manipulator to reach a waypoint and the n columns refers to the number of planned waypoints along the modified trajectory. The density of waypoints may form a gradient where the density is highest between the first waypoints of the modified trajectory matrix and the density is lowest at the last waypoints of the modified trajectory matrix. Density of waypoints refers to the time between the execution of successive waypoints. However, the time between execution of successive waypoints and distance to be travelled between successive waypoints vary at the same rate such that the velocity between successive waypoints remains consistent. For example, as the robotic system executes the motion between the first and second waypoint of the modified trajectory, the time to execution may be 1 sec and the distance traveled by the attachment end 18 may be 1 cm, whereas when the robotic system executes the motion between the tenth and eleventh waypoint of the modified trajectory, the time to execute may be 5 seconds and the distance traveled by the attachment end may be 5 cm. This configuration of waypoints within the modified trajectory matrix dictates that the robotic system is executing waypoints more frequently when the robotic system is executing waypoints at the beginning of the modified trajectory matrix and less frequently when the robotic system is executing waypoints at the end of the modified trajectory matrix. This configuration of waypoints within the modified trajectory matrix more tightly controls the movement of the robotic manipulator the closer the movement is to the point where the feedback occurred while conserving computing power determining and executing the waypoints farther along the trajectory.

Step 605 comprises transmitting the modified trajectory matrix from the feedback adjustment circuit 212 to the continuous optimization circuit 207 to perform continuous optimization of the modified trajectory matrix in the same manner the discrete determination matrix was optimized in method 500 as described above, thereby generating the optimized modified trajectory matrix. The optimized modified trajectory matrix may then be transmitted from the continuous optimization circuit 207 to the matrix parsing circuit 209. Each column of the optimized modified trajectory matrix may then be transmitted to the mobile base interface circuit 210 and the robotic manipulator interface circuit 211 in the same manner as discussed above in reference to the optimized trajectory matrix, such that the first six rows of the optimized modified trajectory matrix is transmitted to and executed by to the robotic manipulator interface circuit and the last three rows of the optimized modified trajectory matrix are transmitted to and executed by the mobile base interface circuit.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the terms “system” may refer to, for example, software, firmware and/or circuitry configured to perform any of the aforementioned operations. Software may be embodied as a software package, code, instructions, instruction sets and/or data recorded on non-transitory, computer-readable storage devices. Firmware may be embodied as code, instructions or instruction sets and/or data that are hard-coded (e.g., nonvolatile) in memory devices. “Circuitry” or “Circuit”, as used in any embodiment herein, may comprise, for example, singly or in any combination, hardwired circuitry, programmable circuitry such as processors comprising one or more individual instruction processing cores, state machine circuitry, and/or firmware that stores instructions executed by programmable circuitry and/or future computing circuitry including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), application-specific integrated circuit (ASIC), programmable logic devices (PLD), digital signal processors (DSP), field programmable gate array (FPGA), logic gates, registers, semiconductor device, chips, microchips, chip sets, etc.

Any of the operations described herein may be implemented in a system that includes one or more non-transitory storage devices having stored thereon, individually or in combination, instructions that when executed by circuitry perform one or more operations. Here, the circuitry may include any of the aforementioned circuitry including, for examples, one or more processors, ASICs, ICs, etc., and/or other programmable circuitry. Also, it is intended that operations described herein may be distributed across a plurality of physical devices, such as processing structures at more than one different physical location. The storage device includes any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software executed by a programmable control device.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

What is claimed is:

1. A single kinematic chain robotic control system, comprising:
global planning control circuitry configured to receive initial position data of a robotic manipulator having n_{J} joints and initial position data of a mobile base having n_{M} joints; a joint having at least one degree of freedom; the global planning circuitry further configured to receive a motion plan request that includes at least one waypoint for at least one articulating component coupled to one of the n_{J} joints of the robotic manipulator; a waypoint being a destination of the articulating component of the robotic manipulator in an external environment; the global planning circuitry comprising:
discretized determination circuitry to generate a first combined matrix of joint values for each of the n_{J} mobile base joints and the nu robotic manipulator joints, based on the motion plan request and the initial position data; and
optimization circuitry configured to generate a second combined matrix of joint values for each of the n_{J} mobile base joints and the n_{M} robotic manipulator joints, based on the first combined matrix and one or more optimization parameters associated with the mobile base or the robotic manipulator; and
matrix parsing circuitry configured to receive the second combined matrix and parse the second combined matrix to generate a third matrix of joint values for the robotic manipulator and a fourth matrix of joint values for the mobile robotic base.

2. The single kinematic chain robotic control system of claim 1, further comprising:
feedback adjustment circuitry configured to generate a first modified matrix of joint values for each of the n_{J} joints of the robotic manipulator and n_{M} joints of the mobile base, based on the second combined matrix and a feedback matrix, the feedback matrix comprising actual joint values for the robotic manipulator joints and the mobile base joints generated by one or more sensors,
wherein, the optimized circuitry is further configured to generate a second modified matrix of joint values for each of the n_{J} joints of the robotic manipulator and the n_{M} joints of the mobile base, the second modified matrix being generated based on the first modified matrix and one or more optimization parameters associated with the mobile base or the robotic manipulator,
wherein, the matrix parsing circuitry is further configured to receive the second modified matrix and parse the second modified matrix into a third modified matrix of joint values for the robotic manipulator and a fourth modified matrix of joint values for the mobile base.

3. The feedback adjustment circuitry of claim 2, further configured to generate a first modified matrix by:
determining the joint values within the first matrix which most closely corresponds to the joint values of the actual location data for the robotic manipulator and mobile base;
inserting the joint values of the actual location data into the beginning of the first modified matrix; and
inserting joint values for a set of modified waypoints, the modified waypoints being generated so the connections between successive modified waypoints followings a path in the external environment created by the connections between successive waypoints of the motion plan request, wherein the density of waypoints is highest between the first waypoint and second waypoint and lowest between the second to last and last waypoint, the density of waypoints referring to the time between the execution of successive waypoints.

4. The single kinematic chain robotic control system of claim 2, further comprising:
robotic manipulator interface circuitry configured to receive the third matrix and the third modified matrix from the matrix parsing circuitry, and
mobile base interface circuitry configured to receive the fourth matrix and the fourth modified matrix from the matrix parsing circuitry.

5. The single kinematic chain robotic control system of claim 1, wherein the discretized determination circuitry generates the first combined matrix using inverse kinematics to determine 8 joint space solutions for the robotic manipulator for each mobile base solution for each waypoint in the motion plan request, wherein a mobile base solution is a possible location and orientation of the mobile base in the external environment within a sampling area, a joint state solution being a set of the n_{J} joint values capable of causing the articulating component of the robotic manipulator to arrive at a waypoint.

6. The single kinematic chain robotic control system of claim 5, wherein the discretized determination circuitry generates the first combined matrix by further eliminating invalid joint state solutions.

7. The single kinematic chain robotic control system of claim 6, wherein invalid joint state solutions include joint state solutions that would cause a portion of the robotic manipulator to collide with the mobile base, another portion of the robotic manipulator, and/or an object in an environment surrounding the robotic manipulator.

8. The single kinematic chain robotic control system of claim 5, wherein the discretized determination circuitry generates the first combined matrix by further assigning weights to paths between joint state solutions for successive waypoints of the motion plan request and selecting the paths with the highest weights, where the motion plan request contains more than one waypoint, wherein a path is the required motion of the robotic manipulator and mobile base to move from waypoint to another, the weights being assigned based on cost factors.

9. The single kinematic chain robotic control system of claim 8, wherein the cost factors include:
minimizing the required travel distance along the path between the joint state solutions for successive waypoints;
reducing the instances where the robotic manipulator must change configurations traveling between the joint states for successive waypoints; and/or
reducing the velocity and/or acceleration of the joints of the robotic manipulator and/or the joints of the mobile base when traveling between the joint states for successive waypoints.

10. The single kinematic chain robotic control system of claim 1, wherein the optimization circuitry is further configured to generate the second combined using gradient descent cost optimization.

11. A non-transitory storage device that includes machine-readable instructions that, when executed by one or more processors, cause the one or more processors to perform operations, comprising:
generating a first combined matrix of joint values each of joint of a robotic manipulator having n_{J} joints and each joint of a mobile base having n_{M} joints; a joint having at least one degree of freedom; the first combined matrix is based on a motion plan request, initial position data of the robotic manipulator and initial position data of the mobile robotic base; the motion plan request including at least one waypoint for at least one articulating component of the robotic manipulator; a waypoint being a destination of the articulating component of the robotic manipulator in an external environment;
generating a second combined matrix of joint values for each of the n_{J} mobile base joints and the n_{M} robotic manipulator joints, based on the first combined matrix and one or more optimization parameters associated with the mobile base or the robotic manipulator; and
parsing the second combined matrix to generate a third matrix of joint values for the robotic manipulator and a fourth matrix of joint values for the mobile robotic base.

12. The non-transitory storage device that includes machine-readable instructions that, when executed by one or more processors, cause the one or more processors to perform operations, of claim 11, further comprising:
generating a first modified matrix of joint values for each of the n_{J} joints of the robotic manipulator and n_{M} joints of the mobile base, based on the second combined matrix and a feedback matrix, the feedback matrix comprising actual position data for the robotic manipulator joints and the mobile base joints generated by one or more sensors;
generating a second modified matrix of joint values for each of the n_{J} joints of the robotic manipulator and the n_{M} joints of the mobile base, the second modified matrix being generated based on the first modified matrix and one or more optimization parameters associated with the mobile base or the robotic manipulator; and
parsing the second modified matrix into a third modified matrix of joint values for the robotic manipulator and a fourth modified matrix of joint values for the mobile base.

13. The generation of the first modified matrix of claim 12, further comprising,
determining the joint values within the first matrix which most closely corresponds to the joint values of the actual location data for the robotic manipulator and mobile base;
inserting the joint values of the actual location data into the beginning of the first modified matrix; and
inserting joint values for a set of modified waypoints, the modified waypoints being generated so the connections between successive modified waypoints followings a path in the external environment created by the connections between successive waypoints of the motion plan request, wherein the density of waypoints is highest between the first waypoint and second waypoint and lowest between the second to last and last waypoint, the density of waypoints referring to the time between the execution of successive waypoints.

14. The non-transitory storage device that includes machine-readable instructions that, when executed by one or more processors, cause the one or more processors to perform operations, of claim 11, further comprising:
transmitting the third matrix and the third modified matrix to robotic manipulator interface circuitry configured to cause the robotic manipulator to execute the joint values contained within the third matrix and the third modified matrix; and
transmitting the fourth matrix and the fourth modified matrix to mobile base interface circuitry configured to cause the mobile base to execute the joint values contained within the fourth matrix and the fourth modified matrix.

15. The generation of the first combined matrix of claim 1, further comprising, using inverse kinematics to determine 8 joint space solutions for the robotic manipulator for each mobile base solution for each waypoint in the motion plan request, wherein a mobile base solution is a possible location and orientation of the mobile base in the external environment within a sampling area, a joint state solution being a set of n_{J} joints values capable of causing the articulating component of the robotic manipulator to arrive at a waypoint.

16. The non-transitory storage device that includes machine-readable instructions that, when executed by one or more processors, cause the one or more processors to perform operations, of claim 15, further comprising, eliminating invalid joint state solutions after generating the 8 joint space solutions for the robotic manipulator for each mobile base solution for each waypoint in the motion plan request.

17. The non-transitory storage device that includes machine-readable instructions that, when executed by one or more processors, cause the one or more processors to perform operations of claim 16, wherein invalid joint state solutions include joint state solutions that would cause a portion of the robotic manipulator to collide with the mobile base, another portion of the robotic manipulator, and/or an object in an environment surrounding the robotic manipulator.

18. The non-transitory storage device that includes machine-readable instructions that, when executed by one or more processors, cause the one or more processors to perform operations, of claim 15, further comprising, generating the first combined matrix by further assigning weights to paths between joint state solutions for successive waypoints of the motion plan request and selecting the paths with the highest weights, where the motion plan request contains more than one waypoint, wherein a path is the required motion of the robotic manipulator and mobile base to move from waypoint to another, the weights being assigned based on cost factors.

19. The non-transitory storage device that includes machine-readable instructions that, when executed by one or more processors, cause the one or more processors to perform operations, of claim 18, wherein the cost factors include:
minimizing the required travel distance along the path between the joint states solutions for successive waypoints;
reducing the instances where the robotic manipulator must change configurations traveling between the joint states for successive waypoints; and/or
reducing the velocity and/or acceleration of the joints of the robotic manipulator and/or the joints of the mobile base when traveling between the joint states for successive waypoints.

20. The non-transitory storage device that includes machine-readable instructions that, when executed by one or more processors, cause the one or more processors to perform operations, of claim 11, further comprising, generating the second combined using gradient descent cost optimization.
